(19) United States
(12) Patent Application Publication
(10) Pub. No.: US 2017/0118524 A1
(43) Pub. Date: Apr. 27, 2017

(54) Method, Server, Client and System for Acquiring Program Lists

(71) Applicants: Le Holdings (Beijing) Co., Ltd., Beijing (CN); Le Shi Zhi Xin Electronic Technology (Tianjin) Limited, Tianjin (CN)

(72) Inventor: Xianke Liu, Tianjin (CN)

(73) Assignees: Le Holdings (Beijing) Co., Ltd., Beijing (CN); Le Shi Zhi Xin Electronic Technology (Tianjin) Limited, Tianjin (CN)

(21) Appl. No.: 15/241,424

(22) Filed: Aug. 19, 2016

Related U.S. Application Data
(63) Continuation of application No. PCT/CN2016/086838, filed on Jun. 23, 2016.

(30) Foreign Application Priority Data
Oct. 22, 2015 (CN) 201510696056.X

(51) Int. Cl. H04N 21/482; H04N 21/84

(52) U.S. Cl. CPC H04N 21/4821; H04N 21/4826; H04N 21/4828; H04N 21/84; H04L 67/02

(57) ABSTRACT

Disclosed is a method for acquiring program lists, including: receiving a program list request from a client; calculating out current-time programs of all channels, and arranging the current-time programs of all the channels into a current-time program list of all the channels; and sending the current-time program list of all the channels to the client, a current-time program of each channel being differentiated from the current-time program list of all the channels according to an ID of each channel and displayed by the client. The present invention also provides a device for acquiring program lists. Through the technical solution of the present invention, a conflict between the urgency for obtaining the current-time program and the time consumption for obtaining a complete program list is solved, the intensity of a session between the client and the server is reduced, and the pressure of the server is relieved.

### CROSS REFERENCE TO RELATED APPLICATIONS

This application is a continuation of International Application No. PCT/CN2016/086838, filed on Jun. 23, 2016, which is based upon and claims priority to Chinese Patent Application No. 201510696056.X, filed on Oct. 22, 2015, the entire contents of which are incorporated herein by reference.

### TECHNICAL FIELD

The disclosure relates to the field of program list acquisition technologies, and more particularly, to a method and a device for acquiring program lists.

### BACKGROUND

In the field of videos, a current program is acquired according to a complete program list and current time (a specific function is calcCurrentProgram (List<Program>)), and is calculated in real time when a UI needs to show the current program. To be specific, the program includes start time, end time, program name and other information. When calculating the current program, the current program is calculated according to system time; if the program is after the start time or is just between the start time and the end time at present, then the program is judged as the current program. All the time above is based on UTC time.

Because programs of a channel may be changed, a round of program list will be acquired from a server after an application is restarted; moreover, a round (10 h) will be acquired at regular intervals during an operation period, to ensure that the program list is in time and effective.

For example: a full-video TV application has more than 500 channels at present, and a program list of each channel is acquired in sequence. After a program list of a certain channel is acquired, a current program of the channel may be calculated.

For example: there are N channels, and each channel has a unique id, ranging from 1 to N; there will be N sessions which may occur densely. A primitive of program list data from JSON to an HTTP session is as follows:

| | |
|---|---|
| http://server/programList/1 | programList1.json |
| http://server/programList/2 | programList2.json |
| . . . | . . . |
| http://server/programList/N | programListN.json |

When the application is started, playing of a channel while being quitted last time will be recovered, and program lists of all channels are started to be acquired in sequence.

It is found by the inventor during the process of research and development that one HTTP session with a server is required when acquiring the program list in each time, which will spend certain time. Because the application has a number of channels, total time spent will be relatively long after accumulating, and the current program cannot be calculated out if a program list at the rear is not acquired. Even after the program is played for several minutes and a user wants to switch to a rear channel, the program lists of the channels are not completely acquired yet, which is not beneficial for the user experience, and the pressure of the server is relatively high in the meanwhile.

### SUMMARY

Based on the problems above, the embodiments of the present invention provide a method for acquiring program lists, which calculates out current-time programs of all channels through a server, arranges the current-time programs of all the channels into a current-time program list of all the channels, then sends the current-time programs of all the channels to a client, and acquires a subsequent complete program list of all the channels continuously at the background, so that a conflict between the urgency for obtaining the current-time program and the time consumption for obtaining the complete program list is solved, the intensity of a session between the client and the server is reduced, and the pressure of the server is relieved. The embodiments of the present invention also provide a device for acquiring program lists.

In a first aspect, the embodiment of the present invention provides a method for acquiring program lists, including: a step of receiving program list request, including: receiving a program list request from a client; a step of calculating and arranging current-time program list of all channels, including: calculating out current-time programs of all channels, and arranging the current-time programs of all the channels into a current-time program list of all the channels; and a step of sending current-time program list of all channels, including: sending the current-time program list of all the channels to the client, a current-time program of each channel being differentiated from the current-time program list of all the channels according to an ID of each channel and displayed by the client.

In a second aspect, the present invention provides an electronic device, including a memory and at least one central processing unit, where the memory is connected to the at least on central processing unit by using a bus, the memory is configured to store a computer instruction, and when the device runs, the at least on central processing units executes the device to execute the following operations: receiving program list request, including: receiving a program list request from a client; calculating and arranging current-time program list of all channels, including: calculating out current-time programs of all channels, and arranging the current-time programs of all the channels into a current-time program list of all the channels; and sending current-time program list of all channels, including: sending the current-time program list of all the channels to the client, a current-time program of each channel being differentiated from the current-time program list of all the channels according to an ID of each channel and displayed by the client.

In a third aspect, the present invention provides a non-volatile computer readable storage medium, where the non-volatile computer readable storage medium stores a computer instruction, and a computer executes the computer instruction to execute the following operations: receiving program list request, including: receiving a program list request from a client; calculating and arranging current-time program list of all channels, including: calculating out current-time programs of all channels, and arranging the current-time programs of all the channels into a current-time program list of all the channels; and sending current-time program list of all channels, including: sending the current-time program list of all the channels to the client, a current-time program of each channel being differentiated from the current-time program list of all the channels according to an ID of each channel and displayed by the client.

By employing the foregoing technical solution the following advantageous effects will be produced:

The current-time programs of all the channels are calculated through the server, and the current-time programs of all the channels are arranged into the current-time program list of all the channels, then the current-time programs of all the channels are sent to the client, and the subsequent complete program list of all the channels are acquired continuously at the background, so that a conflict between the urgency for obtaining current-time the program and the time consumption for obtaining the complete program list is solved, the intensity of a session between the client and the server is reduced, and the pressure of the server is relieved.

### BRIEF DESCRIPTION OF THE DRAWINGS

In order to explain the technical solutions in the detailed embodiments of the present invention more clearly, the figures used in the embodiments will be simply introduced hereinafter. It is apparent that the figures described hereinafter are merely some embodiments of the present invention, and those having ordinary skills in the art may also obtain other figures according to these figures without going through creative work.

FIG. 1 is a flow chart of a method for acquiring program lists applied on a server according to one embodiment of the present invention;

FIG. 2 is a flow chart of a method for acquiring program lists applied on a server according to another embodiment of the present invention;

FIG. 3 is a flow chart of a method for acquiring program lists applied on a server according to another embodiment of the present invention;

FIG. 4 is a flow chart of a method for acquiring program lists applied on a client according to one embodiment of the present invention;

FIG. 5 is a flow chart of a method for acquiring program lists applied on a client according to another embodiment of the present invention;

FIG. 6 is a flow chart of a method for acquiring program lists applied on a client according to another embodiment of the present invention;

FIG. 7 is a block diagram of a server for acquiring program lists provided according to one embodiment of the present invention;

FIG. 8 is a block diagram of a server for acquiring program lists provided according to another embodiment of the present invention;

FIG. 9 is a block diagram of a server for acquiring program lists provided according to another embodiment of the present invention;

FIG. 10 is a block diagram of a client for acquiring program lists provided according to one embodiment of the present invention;

FIG. 11 is a block diagram of a client for acquiring program lists provided according to another embodiment of the present invention;

FIG. 12 is a block diagram of a client for acquiring program lists provided according to another embodiment of the present invention; and

FIG. 13 is a block diagram of a device for acquiring program lists provided according to one embodiment of the present invention;

FIG. 14 is a hardware structure diagram of an electronic device for performing the method for acquiring program lists according to one embodiment of the present disclosure.

### DETAILED DESCRIPTION

The specific embodiments of the present invention will be described clearly and completely hereinafter with reference to the accompanying figures. Apparently, the embodiments described are some, but not all embodiments of the present invention. Other embodiments derive by those having ordinary skills in the art on the basis of the embodiments of the invention without going through creative efforts shall all fall within the protection scope of the present invention. The technical features involved in different embodiments of the present invention described herein may be combined mutually as long as no conflictions are constituted thereamong.

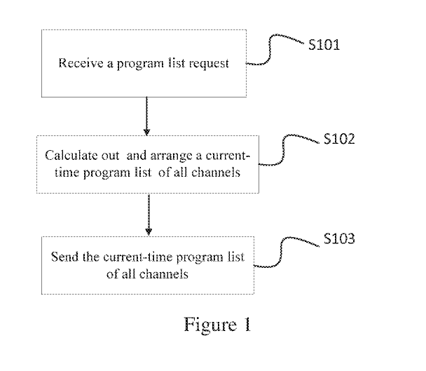

Referring to FIG. 1, one embodiment of the present invention provides a method for acquiring program lists, including: a step of receiving program list request S101, including: receiving a program list request from a client; a step of calculating and arranging current-time program list of all channels S102, including: calculating current-time programs of all channels, and arranging the current-time programs of all the channels into a current-time program list of all the channels; and a step of sending current-time program list of all channels S103, including: sending the current-time program list of all the channels to the client, a current-time program of each channel being differentiated from the current-time program list of all the channels according to an ID of each channel and displayed by the client.

The method for acquiring program lists provided by the embodiment is applied on the server. For a user, a value of a current-time program is maximum. The pressure of the server is relieved through a manner of firstly acquiring the current-time program list of each channel.

To be specific, when the server receives the program list request from the client, the current-time programs of all the channels are calculated out, and the current-time programs of all the channels are arranged into the current-time program list of all the channels.

Then the current-time program list of all the channels is sent to the client, a current-time program of each channel being differentiated from the current-time program list of all the channels according to an ID of each channel and displayed by the client.

For the server, the program lists of all the channels may be acquired through calculating the current-time program of each channel, then arranging the current-time programs of all the channels into the current-time program list of all the channels by the server and then returning the current-time program list of all the channels to the client; in this way, the current programs of all the channels may be acquired by just one session. The subsequent complete program list is acquired continuously in the background; for the user, the value of the current program is great, and the subsequent complete program list of all the channels is continuously acquired by the server, then the current program may be calculated by the client according to the complete program list, so that a conflict between the urgency for obtaining the current-time program and the time consumption for obtaining the complete program list is solved, the intensity of a session between the client and the server is reduced, and the pressure of the server is relieved.

For example: there are N channels, the client acquires current-time programs of all channels from the server through one HTTP session, and then acquires a complete program list of a corresponding channel through an ID of the channel subsequently.

| | |
|---|---|
| http://server/currentProgram | currentProgramList.json |

A structure of a currentProgramList is as follows:
{
1{currentProgram}
2{currentProgram}
...
N{currentProgram}
}.

In conclusion, the method for acquiring program lists provided by the present invention is equivalent to performing currentProgram once as well as programList N times, so that the intensity of the session between the client and the server is reduced, and preferably acquires the current-time program, while the time for acquiring the current-time program is reduced from 5 min in the original to 10 s, so that an acquisition speed is increased, and the user experience is improved.

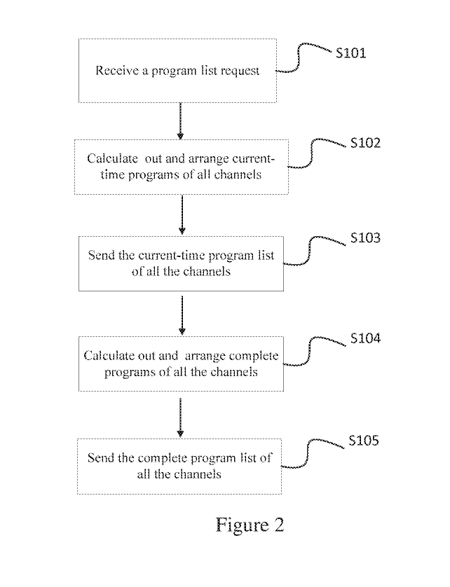

Referring to FIG. 2, in one embodiment, after the step of sending the current-time program list of all the channels S103, the method further includes the following steps: a step of calculating and arranging complete program list of all channels S104, including: calculating complete programs of all the channels, and arranging the complete programs of all the channels into a complete program list of all the channels; and a step of sending complete program list of all channels S105, including: sending the complete program list of all the channels to the client, the complete program list of each channel being differentiated from the complete program list of all the channels according to the ID of each channel by the client and being displayed.

That is, after the server sends the current-time program list of all the channels to the client, the complete program list of all the channels is then calculated and arranged, and then the complete program list of all the channels is sent to the client for the client to differentiate the complete program list of each channel according to the ID of each channel and display the complete program list. Through such a manner, the complete program list of all the channels is acquired after acquiring the current-time program, so that a conflict between the urgency for obtaining the current-time program and the time consumption for obtaining the complete program list is solved, the pressure of the server is relieved, and the user experience is improved.

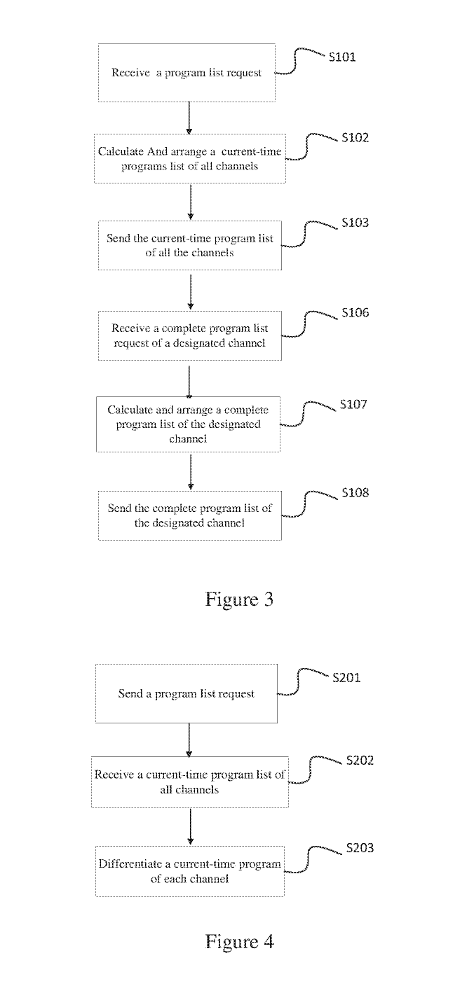

Referring to FIG. 3, in one embodiment, after the step of sending the current-time program list of all the channels S103, the method further includes the following steps: a step of receiving complete program list request of designated channel S106, including: receiving a complete program list request of a designated channel from the client, wherein the complete program list request list of the designated channel includes an ID of each designated channel; a step of calculating and arranging complete program list of all channels S107, including: calculating out all current-day programs of each designated channel according to the ID of each designated channel, and arranging all the current-day programs of all the designated channel into the complete program list of the designated channel; and a step of sending complete program list of designated channel S108, including: sending the complete program list of the designated channel to the client, the complete program list of each designated channel being differentiated from the complete program list of the designated channel according to the ID of each designated channel and displayed by the client.

According to requirements, the server may also separately calculate and arrange all the current-day programs of the designated channel, and arrange all the current-day programs of all the designated channel into the complete program list of the designated channel, then send the complete program list of the designated channel to the client, the complete program list of each designated channel being differentiated from the complete program list of the designated channel according to the ID of each designated channel and displayed by the client, so that different demands are satisfied, and the pressure of the server is relieved. Wherein, the complete program list request of the designated channel includes the ID of each designated channel, and the server separately calculates and arranges the complete program of the designated channel according to the ID of the designated channel.

Referring to FIG. 4, one embodiment of the present invention provides a method for acquiring program lists, including: a step of sending program list request S201, including: sending a program list request to a server; a step of receiving current-time program list of all channels S202, including: receiving a current-time program list of all channels sent from the server, the current-time program list of all the channels being acquired by the server through calculating out current-time programs of all the channels and arranging the current-time programs of all the channels; and a step of differentiating current-time program of each channel S203, including: differentiating the current-time program of each channel from the current-time program list of all the channels according to an ID of each channel and displaying the program.

The method for acquiring program lists provided by the embodiment is applied on a client. For a user, a value of a current-time program is maximum. The pressure of the server is relieved by the present invention through a manner of acquiring the current-time program list of each channel.

To be specific, when the client sends the program list request to the server, and when the server receives the program list request from the client, the current-time programs of all the channels are calculated out, and the current-time programs of all the channels are arranged into the current-time program list of all the channels, then the current-time program list of all the channels is sent to the client.

The client acquires the current-time program list of all the channels firstly, and then differentiates the current-time program of each channel from the current-time program list of all the channels received by the server according to the ID of each channel and displayed by the client.

For the server, the program lists of all the channels may be acquired through calculating the current-time program of each channel and then arranging the current-time programs of all the channels into the current-time program list of all the channels by the server and then returning the current-time program list of all the channels to the client; in this way, the current programs of all the channels may be acquired by one session only. The subsequent complete program list is acquired continuously in the background; for the user, the value of the current program is great, and the subsequent complete program list of all the channels is continuously acquired by the server, then the current program may be calculated by the client according to the complete program list, so that a conflict between the urgency for obtaining the current-time program and the time consumption for obtaining the complete program list is solved, the intensity of a session between the client and the server is reduced, and the pressure of the server is relieved.

For example: there are N channels, the client acquires current-time programs of all channels from the server through one HTTP session, and then acquires a complete program list of a corresponding channel through an ID of the channel subsequently.

In conclusion, the method for acquiring program lists provided by the present invention is equivalent to performing currentProgram once as well as programList N times, so that the intensity of the session between the client and the server is reduced, and preferably acquires the current-time program, while the time for acquiring the current-time program is reduced from 5 min in the original to 10 s, so that an acquisition speed is increased, and the user experience is improved.

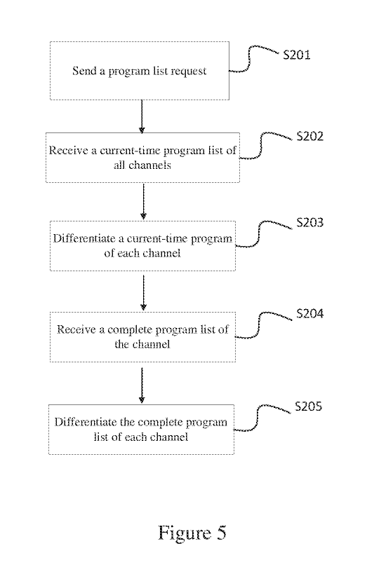

Referring to FIG. 5, in one embodiment, after the step of differentiating the current-time program of each channel S203, the method further includes the following steps: a step of receiving complete program list of all channels S204, including: receiving a complete program list of all the channels sent from the server, the complete program list of all the channels being acquired by the server through calculating out complete programs of all the channels and arranging the complete programs of all the channels; and a step of differentiating complete program list of each channel S205, including: differentiating the complete program list of each channel from the complete program list of all the channels according to the ID of each channel to acquire and display the complete program list of each channel.

That is, after receiving the current-time program list of all the channels, the client continuously receives the complete program list of all the channels calculated and arranged by the server, and then the client differentiates the complete program list of each channel from the program list of all the channels sent by the server according to the ID of each channel and display the complete program list. Through such a manner, the complete program list of all the channels is acquired after acquiring the current-time program, so that a conflict between the urgency for obtaining the current-time program and the time consumption for obtaining the complete program list is solved, the pressure of the server is relieved, and the user experience is improved.

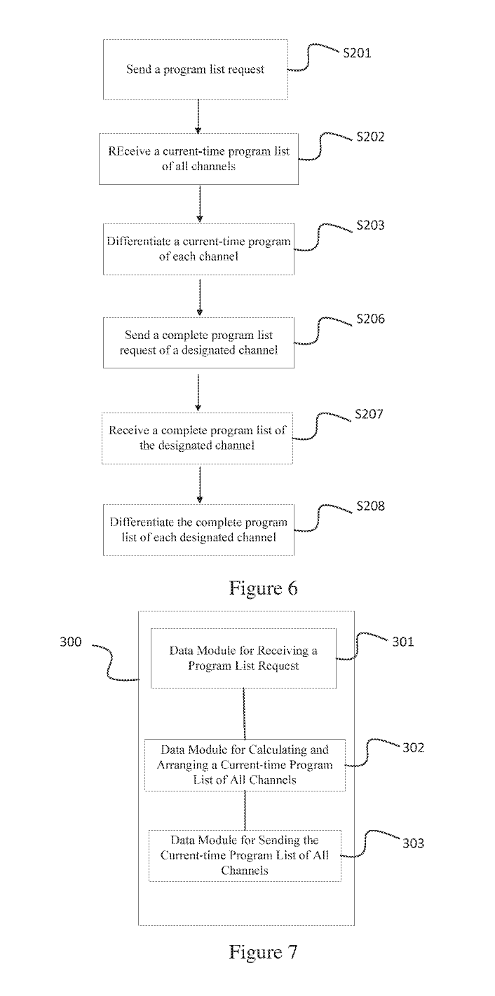

Referring to FIG. 6, in one embodiment, after the step of differentiating the current-time program of each channel S203, the method further includes the following steps: a step of sending complete program list of designated channel S206, including: sending a complete program list request of a designated channel to the server, wherein the complete program list request of the designated channel includes an ID of each designated channel; a step of receiving complete program list of designated channel S207, including: receiving the complete program list of the designated channel sent from the server, the complete program list of the designated channel being acquired through calculating out all current-day programs of each designated channel by the server and arranging all the current-day programs of all the designated channels; and a step of differentiating complete program list of each designated channel S208, including: differentiating the complete program list of each designated channel from the complete program list of the designated channel according to the ID of each designated channel to acquire and display the complete program list of each designated channel.

According to requirements, the client may also request a complete program list of some designated channels; after arranging the complete program list of the designated channel, the server sends the complete program list of the designated channel to the client, then the client differentiates a complete program list of each designated channel from the complete program list of the designated channel according to the ID of each designated channel and displays the complete program list of each designated channel, so that different demands are satisfied, and the pressure of the server is relieved. Wherein, the complete program list request of the designated channel includes the ID of each designated channel, and the server separately calculates and arranges the complete program of the designated according to the ID of the designated channel.

Referring to FIG. 7, one embodiment of the present invention provides a server for acquiring program lists 300, including: a data module for receiving program list request 301 configured to receive a program list request from a client; a data module for calculating and arranging a current-time program list of all channels 302 configured to calculate out current-time programs of all channels, and arrange the current-time programs of all the channels into the current-time program list of all the channels; and a data module for sending the current-time program list of all channels 303 configured to send the current-time program list of all the channels to the client, a current-time program of each channel being differentiated from the current-time program list of all the channels according to an ID of each channel and displayed by the client.

The server 300 receives the program list request from the client through the data module for receiving program list request 301, calculates out the current-time programs of all the channels through the data module for calculating and arranging current-time program list of all channels 302 after receiving the program list request of the client, and arranges the current-time programs of all the channels into the current-time program list of all the channels, then sends the current-time program list of all the channels to the client through the data module for sending current-time program list of all channels 303. The current-time program of each channel is differentiated from the current-time program list of all the channels according to the ID of each channel and displayed by the client.

For a user, a value of a current-time program is maximum. The pressure of the server is relieved by the present invention through a manner of firstly acquiring the current-time program list of each channel.

For the server, the program lists of all the channels may be acquired through calculating the current-time program of each channel, then arranging the current-time programs of all the channels into the current-time program list of all the channels by the server and then returning the current-time program list of all the channels to the client; in this way, the current programs of all the channels may be acquired by one session only. The subsequent complete program list is acquired continuously in the background; for the user, the value of the current program is great, and the subsequent complete program list of all the channels is continuously acquired by the server, then the current program may be calculated by the client according to the complete program list, so that a conflict between the urgency for obtaining the current-time program and the time consumption for obtaining the complete program list is solved, the intensity of a session between the client and the server is reduced, and the pressure of the server is relieved.

For example: there are N channels, the client acquires current-time programs of all channels from the server through one HTTP session, and then acquires a complete program list of a corresponding channel through an ID of the channel subsequently.

In conclusion, the server for acquiring program lists provided by the present invention is equivalent to performing currentProgram once as well as programList N times, so that the intensity of the session between the client and the server is reduced, and preferably acquires the current-time program, while the time for acquiring the current-time program is reduced from 5 min in the original to 10 s, so that an acquisition speed is increased, and the user experience is improved.

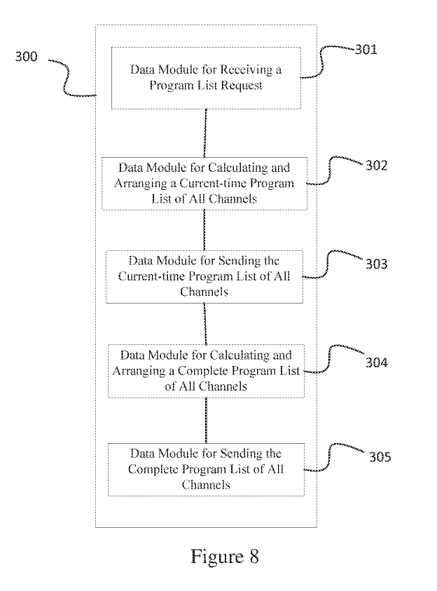

Referring to FIG. 8, in one embodiment, the server for acquiring program lists 300 further includes: a data module for calculating and arranging complete program list of all channels 304 configured to calculate out complete programs of all the channels, and arrange the complete programs of all the channels into a complete program list of all the channels; and a data module for sending complete program list of all channels 305 configured to send the complete program list of all the channels to the client, the complete program list of each channel being differentiated from the complete program list of all the channels according to the ID of each channel and displayed by the client.

That is, after the server sends the current-time program list of all the channels to the client, the complete program list of all the channels is then calculated and arranged through the data module for calculating and arranging complete program list of all channels 304, and then the complete program list of all the channels is sent to the client through the data module for sending complete program list of all channels 305 for the client to differentiate the complete program list of each channel according to the ID of each channel and display the complete program list. Through such a manner, the complete program list of all the channels is acquired after acquiring the current-time program, so that a conflict between the urgency for obtaining the current-time program and the time consumption for obtaining the complete program list is solved, the pressure of the server is relieved, and the user experience is improved.

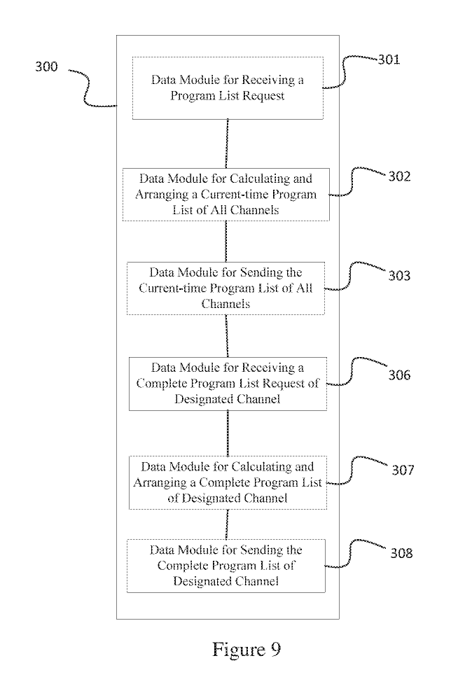

Referring to FIG. 9, in one embodiment, the server for acquiring program lists 300 further includes: a data module for receiving complete program list request of designated channel 306 configured to receive a complete program list request of a designated channel from the client, wherein the complete program list request list of the designated channel includes an ID of each designated channel; a data module for calculating and arranging complete program list of designated channel 307 configured to calculate out all current-day programs of each designated channel according to the ID of each designated channel, and arrange all the current-day programs of all the designated channel day into the complete program list of the designated channel; and a data module for sending complete program list of designated channel 308 configured to send the complete program list of the designated channel to the client, the complete program list of each designated channel being differentiated from the complete program list of the designated channel according to the ID of each designated channel and displayed by the client.

According to requirements, the server 300 may also separately calculate and arrange the complete program of the designated channel according to a request from the client. To be specific, the complete program list request of the designated channel from the client is received through the data module for receiving complete program list request of designated channel 306, then all the current-day programs of all the designated channel are arranged into the complete program list of the designated channel through the data module for calculating and arranging complete program list of designated channel 307, then the complete program list of the designated channel is sent to the client through the data module for sending complete program list of designated channel 308, the complete program list of each designated channel being differentiated from the complete program list of the designated channel according to the ID of each designated channel and displayed by the client, so that different demands are satisfied, and the pressure of the server is relieved. Wherein, the complete program list request of the designated channel includes the ID of each designated channel, and the server separately calculates and arranges the complete program of the designated according to the ID of the designated channel.

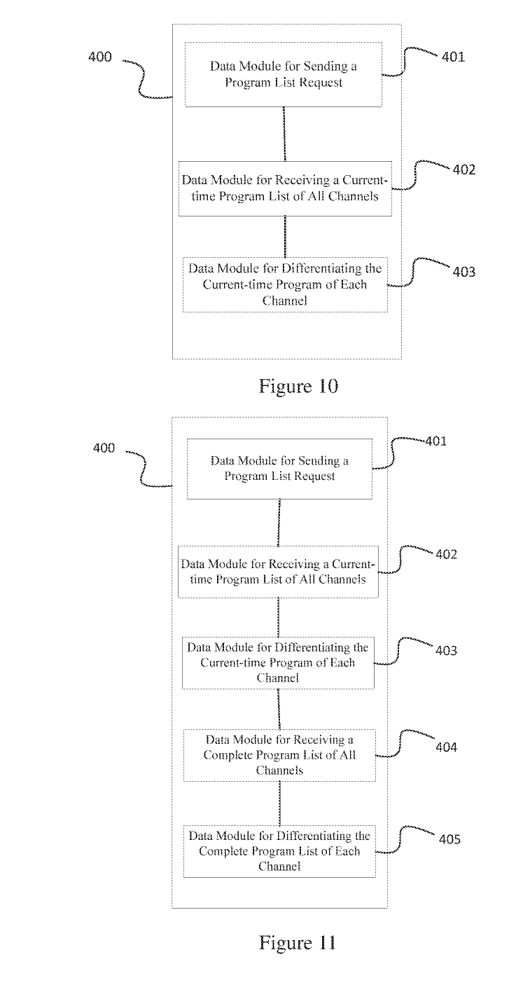

Referring to FIG. 10, one embodiment of the present invention provides a client for acquiring program lists 400, including: a data module for sending program list request 401 configured to send a program list request to the server; a data module for receiving current-time program list of all channels 402 configured to receive a current-time program list of all channels sent from the server, the current-time program list of all the channels being acquired by the server through calculating out current-time programs of all the channels and arranging the current-time programs of all the channels; and a data module for differentiating current-time program of each channel 403 configured to differentiate the current-time program of each channel from the current-time program list of all the channels according to an ID of each channel and display the program.

For a user, a value of a current-time program is maximum. The pressure of the server is relieved by the present invention through a manner of acquiring the current-time program list of each channel.

To be specific, when the client sends the program list request to the server through the data module for sending program list request 401, and when the server receives the program list request from the client, the current-time programs of all the channels are calculated out, and the current-time programs of all the channels are arranged into the current-time program list of all the channels, then the current-time program list of all the channels is sent to the client.

The client firstly acquires the current-time program list of all the channels through the data module for receiving current-time program list of all channels 402 firstly, then differentiates the current-time program list of all the channels received by the data module for differentiating current-time program of each channel 403 from the server, and differentiates the current-time program of each channel from the current-time program list of all the channels according to the ID of each channel and then displays the program.

For the server, the program lists of all the channels may be acquired through calculating the current-time program of each channel and then arranging the current-time programs of all the channels into the current-time program list of all the channels by the server and then returning the current-time program list of all the channels to the client; in this way, the current programs of all the channels may be acquired by one session only. The subsequent complete program list is acquired continuously in the background; for the user, the value of the current program is great, and the subsequent complete program list of all the channels is continuously acquired by the server, then the current program may be calculated by the client according to the complete program list, so that a conflict between the urgency for obtaining the current-time program and the time consumption for obtaining the complete program list is solved, the intensity of a session between the client and the server is reduced, and the pressure of the server is relieved.

For example: there are N channels, the client acquires current-time programs of all channels from the server through one HTTP session, and then acquires a complete program list of a corresponding channel through an ID of the channel subsequently.

In conclusion, the client for acquiring program lists provided by the present invention is equivalent to performing currentProgram once as well as programList N times, so that the intensity of the session between the client and the server is reduced, and preferably acquires the current-time program, while the time for acquiring the current-time program is reduced from 5 min in the original to 10 s, so that an acquisition speed is increased, and the user experience is improved.

Referring to FIG. 11, in one embodiment, the client for acquiring program lists 400 further includes: a data module for receiving complete program list of all channels 404 configured to receive a complete program list of all channels sent from the server, the complete program list of all the channels being acquired by the server through calculating out programs of all the channels and arranging the programs of all the channels; and a data module for differentiating complete program list of each channel 405 configured to differentiate the complete program list of each channel from the complete program list of all the channels according to the ID of each channel to acquire and display the complete program list of each channel.

That is, after receiving the current-time program list of all the channels, the client 400 continuously receives the complete program list of all the channels calculated and arranged by the server through the data module for receiving complete program list of all channels 404, and then the client differentiates the complete program list of each channel from the program list of all the channels sent by the server through the data module for differentiating complete program list of each channel 405 according to the ID of each channel and displays the complete program list. Through such a manner, the complete program list of all the channels is acquired after acquiring the current-time program, so that a conflict between the urgency for obtaining the current-time program and the time consumption for obtaining the complete program list is solved, the pressure of the server is relieved, and the user experience is improved.

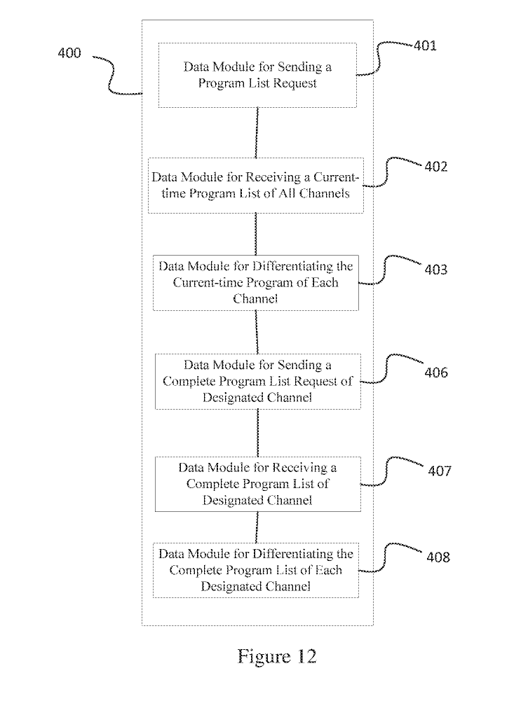

Referring to FIG. 12, in one embodiment, the client for acquiring program lists 400 further includes: a data module for sending complete program list request of designated channel 406 configured to send a complete program list request of a designated channel to the server, wherein the complete program list request of the designated channel includes an ID of each designated channel; a data module for receiving complete program list of designated channel 407 configured to receive the complete program list of the designated channel sent from the server, the complete program list of the designated channel being acquired through calculating out all current-day programs of each designated channel by the server and arranging all the current-day programs of all the designated channels; and a data module for differentiating complete program list of each designated channel 408 configured to differentiate the complete program list of each designated channel from the complete program list of all the channels according to the ID of each channel to acquire and display the complete program list of each channel.

According to requirements, the client 400 may also request a complete program list of some designated channels through the data module for sending complete program list request of designated channel 406; after arranging the complete program list of the designated channel, the server sends the complete program list of the designated channel to the data module for receiving complete program list of designated channel 407, then the data module for differentiating complete program list of each designated channel 408 in the client differentiates a complete program list of each designated channel from the complete program list of the designated channel according to the ID of each designated channel and displays the complete program list of each designated channel, so that different demands are satisfied, and the pressure of the server is relieved. Wherein, the complete program list request of the designated channel includes the ID of each designated channel, and the server separately calculates and arranges the complete program of the designated according to the ID of the designated channel.

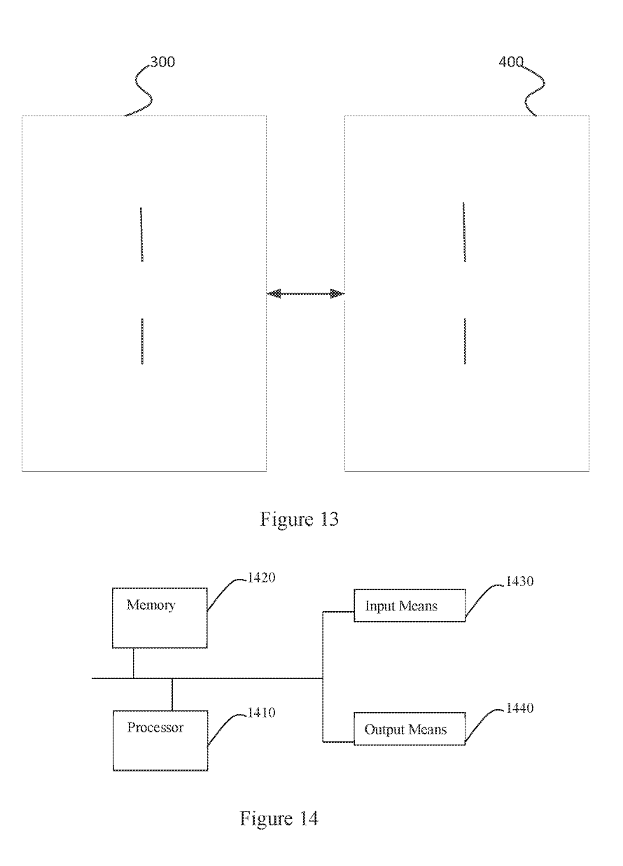

Referring to FIG. 13, one embodiment of the present invention provides a device for acquiring program lists, including a server 300 and a client 400.

Wherein, the server includes: a data module for receiving program list request configured to receive a program list request from a client; a data module for calculating and arranging current-time program list of all channels configured to calculate out current-time programs of all channels, and arrange the current-time programs of all the channels into the current-time program list of all the channels; and a data module for sending current-time program list of all channels configured to send the current-time program list of all the channels to the client.

The client includes: a data module for sending program list request configured to send a program list request to the server; a data module for receiving current-time program list of all channels configured to receive a current-time program list of all channels from the server; and a data module for differentiating current-time program of each channel configured to differentiate the current-time program of each channel from the current-time program list of all the channels according to an ID of each channel and display the program.

For a user, a value of a current-time program is maximum. The pressure of the server is relieved by the present invention through a manner of acquiring the current-time program list of each channel.

For the server, the program lists of all the channels may be acquired through calculating the current-time program of each channel and then arranging the current-time programs of all the channels into the current-time program list of all the channels by the server and then returning the current-time program list of all the channels to the client; in this way, the current programs of all the channels may be acquired by one session only. The subsequent complete program list is acquired continuously in the background; for the user, the value of the current program is great, and the subsequent complete program list of all the channels is continuously acquired by the server, then the current program may be calculated by the client according to the complete program list, so that a conflict between the urgency for obtaining the current-time program and the time consumption for obtaining the complete program list is solved, the intensity of a session between the client and the server is reduced, and the pressure of the server is relieved.

For example: there are N channels, the client acquires current-time programs of all channels from the server through one HTTP session, and then acquires a complete program list of a corresponding channel through an ID of the channel subsequently.

In conclusion, the device for acquiring program lists provided by the present invention is equivalent to performing currentProgram once as well as programList N times, so that the intensity of the session between the client and the server is reduced, and preferably acquires the current-time program, while the time for acquiring the current-time program is reduced from 5 min in the original to 10 s, so that an acquisition speed is increased, and the user experience is improved.

It may be understood by those having ordinary skills in the art that the all or part flows of implementing the methods in the foregoing embodiments may be completed through relevant hardware instructed by a computer program. The program may be stored in a mobile device or a computer readable storage medium, and the program while performing includes one or a combination of the flows of the embodiments according to the methods above. Based on such understanding, the foregoing technical solutions essentially, or the part contributing to the prior art, or the part of the technical solution may be implemented in the form of a software product. The computer software product may be stored in a storage medium and includes several instructions for instructing a mobile terminal (which may be a personal computer, a server, or a network device, a mobile phone so on) to execute the all or a part of steps of the method according to each embodiment of the present invention. While the forementioned storage medium includes: any medium that is capable of storing program codes, such as a USB disk, a mobile hard disk, a read-only memory (ROM, Read-Only Memory), a random access memory (RAM, Random Access Memory), a magnetic disk, or an optical disk.

One embodiment of the present disclosure provides a nonvolatile computer-readable storage medium which stores executable instructions, wherein the method for acquiring program lists according to any one embodiment as above can be performed by the executable instructions.

FIG. 14 is a hardware structure diagram of an electronic device for performing the method for acquiring program lists according to one embodiment of the present disclosure.

As shown in FIG. 14, the electronic device includes one or more processors 1410 and a memory 1420. FIG. 14 takes one processor 1410 as an example.

The electronic device for performing the method for acquiring program lists may further include an input means 1430 and an output means 1440.

The processor 1410, the memory 1420, the input means 1430 and the output means 1440 may be connected via a bus or in other ways. In FIG. 14, these elements are connected via a bus.

The memory 1420 can be used as a nonvolatile computer-readable storage medium, which can store a nonvolatile software program, a nonvolatile computer-executable program, and respective modules. For example, the medium stores program instructions/modules for performing the method for acquiring program lists according to the embodiments of the present disclosure, such as a data module for receiving program list request, a data module for calculating and arranging current-time program list of all channels, a data module for sending current-time program list of all channels, a data module for sending program list request, a data module for receiving current-time program list of all channels, and a data module for differentiating current-time program of each channel, shown in FIG. 13. The processor 1410 executes the nonvolatile software program, instructions and/or modules stored within the memory 1420, so as to perform several functional applications and data processing, particularly, realize the method for acquiring program lists according to the above embodiments as above.

The memory 1420 may include a storage program zone and a storage data zone. The storage program zone may store an operating system and at least one application program for achieving respective functions. The storage data zone may store data created according to the usage of the device for acquiring program lists. In addition, the memory 1420 may further include a high speed random access memory and a nonvolatile memory, e.g. at least one of a disk storage device, a flash memory or other nonvolatile solid storage device. In some embodiments, the memory 1420 may include a remote memory remotely located relative to the processor 1410, and this remote memory may be connected, via a network, to the device for acquiring program lists. For example, the network includes but is not limited within internet, intranet, local area network, mobile communication network and any combination thereof.

The input means 1430 can receive digital or character information inputted, and generate a signal input associated with a user setting and a functional controlling of the device for acquiring program lists. The output means 1440 may include a display device such as a displaying screen.

One or more storage modules are stored within the memory 1420. When said one or more storage modules are operated by one or more processors 1410, the method for acquiring program lists of the above embodiments is performed.

The products as above-mentioned may perform methods provided by the embodiments of the present disclosure, have functional modules for performing the methods, and achieve respective beneficial effects. For those technical details which are not mentioned in this embodiment, please refer to the methods provided by the embodiments of the disclosure.

The electronic device of the embodiment of the present disclosure may be constructed in several forms, which include but are not limited within:

(1) mobile communication device: this type of terminal has a function of mobile communication for main propose of providing a voice/data communication. This type of terminal includes: a smartphone (e.g. iPhone), a multimedia mobile phone, a feature phone, a low-end cellphone and so on;

(2) ultra mobile personal computer device: this type of terminal belongs to a personal computer which has a computing function and a processing function. In general, this type of terminal has a networking characteristic. This type of terminal includes: PDA, MID, UMPC and the like, e.g. iPad;

(3) portable entertainment device: this type of device can display and play multimedia contents. This type of device includes an audio/video player (e.g. iPod), a handheld game console, an electronic book, an intelligent toy, and a portable vehicle navigation device;

(4) server: the server provides a computing service. The construction of a server includes a processor, a hard disk, an internal memory, a system bus and so on, which is similar to the construction of a general computer but can provide more reliable service. Therefore, with respect to processing ability, stability, reliability, security, extendibility and manageability, a server has to meet a higher requirement; and

(5) other electronic devices having data interchanging functions.

The above embodiments are for purposes of illustration and description to the technical solution of the present invention merely, but are not intended to limit the present invention. Although the embodiments of the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the claims.

What is claimed is:

1. A method for acquiring program lists, applied at an electronic device, comprising:
receiving a program list request from a client;
calculating out current-time programs of all channels, and arranging the current-time programs of all the channels into a current-time program list of all the channels; and
sending the current-time program list of all the channels to the client, a current-time program of each channel being differentiated from the current-time program list of all the channels according to an ID of each channel and displayed by the client.

2. The method for acquiring program lists according to claim 1, wherein after the step of sending the current-time program list of all the channels to the client, the current-time program of each channel being differentiated from the current-time program list of all the channels according to the ID of each channel and displayed by the client, the method further comprises the following steps:
calculating out complete programs of all the channels, and arranging the complete programs of all the channels into a complete program list of all the channels; and
sending the complete program list of all the channels to the client, the complete program list of each channel being differentiated from the complete program list of all the channels according to the ID of each channel and displayed by the client.

3. The method for acquiring program lists according to claim 1, wherein after the step of sending the current-time program list of all the channels to the client, the current-time program of each channel being differentiated from the current-time program list of all the channels according to the ID of each channel and displayed by the client, the method further comprises the following steps:
receiving a complete program list request of a designated channel from the client, wherein the complete program list request list of the designated channel comprises an ID of each designated channel;
calculating out all current-day programs of each designated channel according to the ID of each designated channel, and arranging all the current-day programs of all the designated channel into the complete program list of the designated channel; and
sending the complete program list of the designated channel to the client, the complete program list of each designated channel being differentiated from the complete program list of the designated channel according to the ID of each designated channel and displayed by the client.

4. An electronic device, comprising:
at least one processor; and
a memory communicably connected with the at least one processor for storing instructions executable by the at least one processor, wherein execution of the instructions by the at least one processor causes the at least one processor to:
receive a program list request from a client;
calculate out current-time programs of all channels, and arranging the current-time programs of all the channels into a current-time program list of all the channels; and
send the current-time program list of all the channels to the client, a current-time program of each channel being differentiated from the current-time program list of all the channels according to an ID of each channel and displayed by the client.

5. The electronic device according to claim 4, wherein after the step of sending the current-time program list of all the channels to the client, the current-time program of each channel being differentiated from the current-time program list of all the channels according to the ID of each channel and displayed by the client, the method further comprises the following steps:
calculating out complete programs of all the channels, and arranging the complete programs of all the channels into a complete program list of all the channels; and
sending the complete program list of all the channels to the client, the complete program list of each channel being differentiated from the complete program list of all the channels according to the ID of each channel and displayed by the client.

6. The electronic device according to claim 4, wherein after the step of sending the current-time program list of all the channels to the client, the current-time program of each channel being differentiated from the current-time program list of all the channels according to the ID of each channel and displayed by the client, the method further comprises the following steps:
receiving a complete program list request of a designated channel from the client, wherein the complete program list request list of the designated channel comprises an ID of each designated channel;
calculating out all current-day programs of each designated channel according to the ID of each designated channel, and arranging all the current-day programs of all the designated channel into the complete program list of the designated channel; and
sending the complete program list of the designated channel to the client, the complete program list of each designated channel being differentiated from the complete program list of the designated channel according to the ID of each designated channel and displayed by the client.

7. A non-transitory computer-readable storage medium, wherein the computer-readable medium records computer executable instructions thereon, the computer executable instructions are adapted to perform:
receiving a program list request from a client;
calculating out current-time programs of all channels, and arranging the current-time programs of all the channels into a current-time program list of all the channels; and
sending the current-time program list of all the channels to the client, a current-time program of each channel being differentiated from the current-time program list of all the channels according to an ID of each channel and displayed by the client.

8. The computer-readable medium according to claim 7, wherein after the step of sending the current-time program list of all the channels to the client, the current-time program of each channel being differentiated from the current-time program list of all the channels according to the ID of each channel and displayed by the client, the method further comprises the following steps:
calculating out complete programs of all the channels, and arranging the complete programs of all the channels into a complete program list of all the channels; and
sending the complete program list of all the channels to the client, the complete program list of each channel being differentiated from the complete program list of all the channels according to the ID of each channel and displayed by the client.

9. The computer-readable medium according to claim 7, wherein after the step of sending the current-time program list of all the channels to the client, the current-time program of each channel being differentiated from the current-time program list of all the channels according to the ID of each channel and displayed by the client, the method further comprises the following steps:
receiving a complete program list request of a designated channel from the client, wherein the complete program list request list of the designated channel comprises an ID of each designated channel;
calculating out all current-day programs of each designated channel according to the ID of each designated channel, and arranging all the current-day programs of all the designated channel into the complete program list of the designated channel; and
sending the complete program list of the designated channel to the client, the complete program list of each designated channel being differentiated from the complete program list of the designated channel according to the ID of each designated channel and displayed by the client.
